(19) United States
(12) Patent Application Publication
(10) Pub. No.: US 2012/0301010 A1
(43) Pub. Date: Nov. 29, 2012

(54) COMPUTING DEVICE, STORAGE MEDIUM AND METHOD FOR IDENTIFYING COMPONENTS OF PCB

(75) Inventors: CHUAN-CHI LIU, Tu-Cheng (TW); HUI-CHI LO, Tu-Cheng (TW)

(73) Assignee: HON HAI PRECISION INDUSTRY CO., LTD., Tu-Cheng (TW)

(21) Appl. No.: 13/427,886

(22) Filed: Mar. 23, 2012

(30) Foreign Application Priority Data
May 27, 2011 (TW) 100118566

(51) Int. Cl. G06K 9/00

(52) U.S. Cl. 382/147

(57) ABSTRACT

In a method for identifying components of a printed circuit board (PCB) using a computing device, the computing device connects to a digital scanner and a display device. The digital scanner scans a PCB to generate a PCB file. The method selects one or more location points from the PCB, locates a coordinate point for each location point according to the PCB file, and builds a coordinate relationship between each location point and the coordinate point. The method converts the PCB file into a PCB image using a visual graphic tool, searches a test point on the PCB image according to a name of a component of the PCB, identifies the component on the PCB according to the test point, and obtains a coordinate value of the component according to the coordinate relationship. The display device displays the name and the coordinate value of the component for users.

### BACKGROUND

1. Technical Field

The embodiments of the present disclosure relate to printed circuit board (PCB) test systems and methods, and more particularly to a computing device, storage medium, and method for identifying components of a PCB.

2. Description of Related Art

PCBs are widely used in electronic devices, such as computers, servers, and mobile communication devices, for example. PCBs provide a mechanism for implementing a circuit design (i.e., the interconnection of the electrical devices and components) for use, e.g., in a computer system. For testing components of a PCB, a location of each of the components must be determined. Testing simple PCBs may be done manually without too much trouble. However, a complex PCB may include a large number of components, such as resistors, capacitors, and inductors. It is difficult to identify each of the components that is installed on the PCB, thus testing a complex PCB becomes more and more complex and tedious. Therefore, it is desirable to have a method for identifying components of a PCB, to address the above-mentioned problems.

### BRIEF DESCRIPTION OF THE DRAWINGS

FIG. 1 is a block diagram of one embodiment of a computing device including a PCB component identifying system.

FIG. 2 is a flowchart of one embodiment of a method for identifying components of a PCB using the computing device of FIG. 1.

FIG. 3 is a schematic diagram illustrating an example of a relationship between a PCB and a PCB image.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

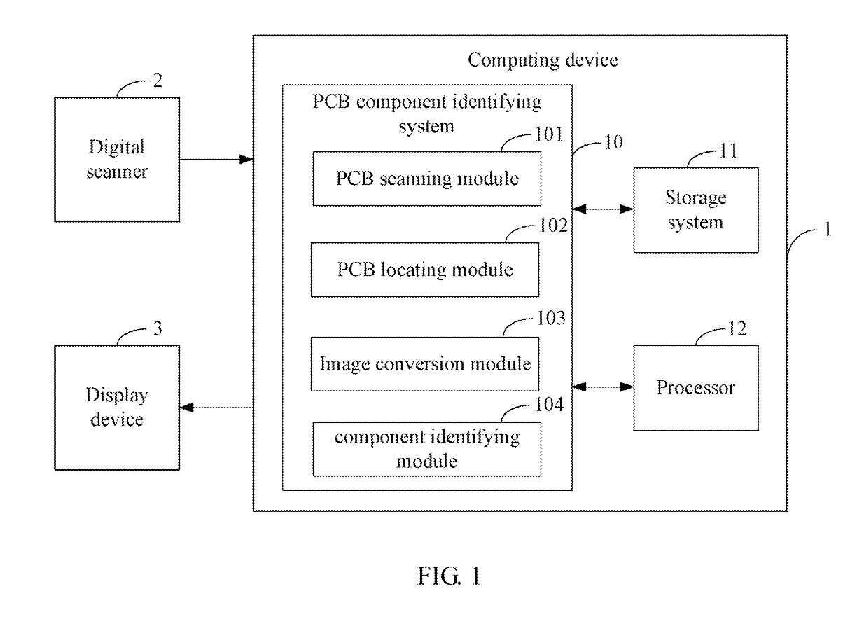

FIG. 1 is a block diagram of one embodiment of a computing device 1 including a printed circuit board (PCB) component identifying system 10. The computing device 1 may further include a storage system 11, and at least one processor 12. In one embodiment, the computing device 1 may be a computer or a server, for example. Each of the components can communicate with the PCB component identifying system 10 through one or more bus lines included in the computing device 1. It is understood that FIG. 1 is only one example of the computing device 1 that includes more or fewer components than those shown in the embodiment, or have a different configuration of the various components.

In the embodiment, the computing device 1 electronically connects to a digital scanner 2 and a display device 3. The digital scanner 2 scans a PCB to digitally obtain PCB data. In one embodiment, the PCB may be an electronic circuit board that includes components, such as resistors, capacitors, and inductors, for example, and may be equipped in computers, game machines, or household appliances. The PCB data may include an ID number of each component, a name of each component, a location of each component, and layout information of each component in the PCB. The display device 3 displays the PCB data for users.

The PCB identifying component system 10 may include a plurality of functional modules that are stored in the storage system 11 and implemented by the at least one processor 12. In one embodiment, the storage system 11 may be an internal storage system, such as a random access memory (RAM) for the temporary storage of information, and/or a read only memory (ROM) for the permanent storage of information. In some embodiments, the storage system 11 may also be an external storage system, such as an external hard disk, a storage chipset, or a data storage medium.

In one embodiment, the PCB component identifying system 10 includes a PCB scanning module 101, a PCB locating module 102, an image conversion module 103, and a component identifying module 104. The modules 101-104 may comprise computerized instructions in the form of one or more programs that are stored in the storage system 11 and executed by the at least one processor 12 to provide functions for implementing the modules. A detailed description of each module will be given in the following paragraphs.

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

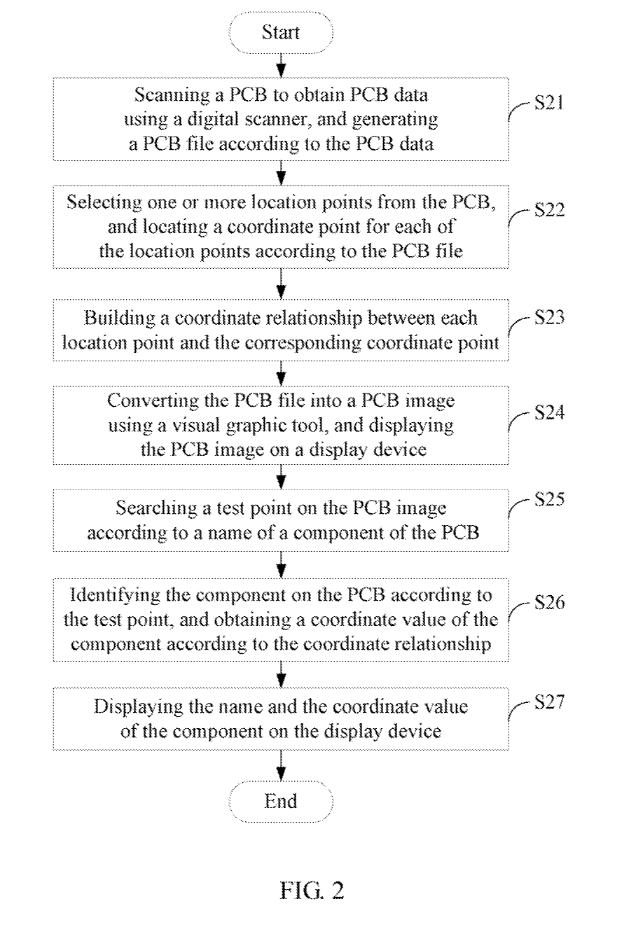

FIG. 2 is a flowchart of one embodiment of a method for identifying components of a PCB using the computing device 1 of FIG. 1. Depending on the embodiment, additional blocks may be added, others removed, and the ordering of the blocks may be changed.

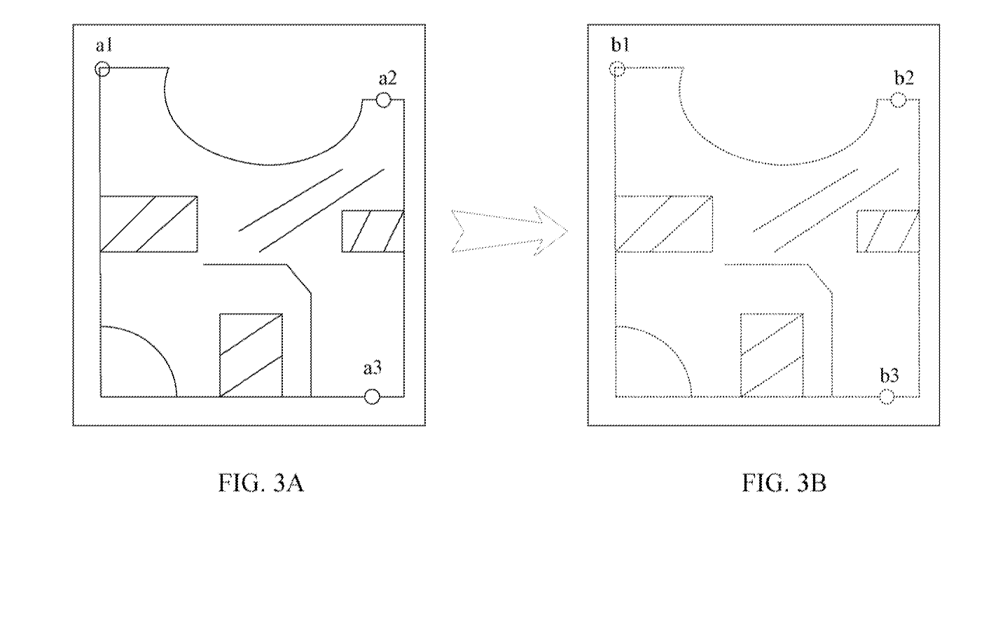

In block S21, the PCB scanning module 101 scans a PCB (shown in FIG. 3A) to obtain the PCB data using the digital scanner 2, and generates a PCB file (shown in FIG. 3B) according to the PCB data. In the embodiment, the PCB may be a electronic circuit board that includes components, such as resistors, capacitors, and inductors.

In block S22, the PCB locating module 102 selects one or more location points from the PCB, and locates a coordinate point for each of the location points according to the PCB file. Referring to FIG. 3A, the PCB locating module 102 may select the location points “a1”, “a2” and “a3” from the PCB, and locates the coordinate point for each of the location points. Referring to FIG. 3B, the coordinate point “b1” corresponds to the location point “a1”, the coordinate point “b2” corresponds to the location point “a2”, and the coordinate point “b3” corresponds to the location point “a3”.

In block S23, the PCB locating module 102 builds a coordinate relationship between each of the location points and the corresponding coordinate point, and records a coordinate value of each of the components in the PCB file according to the coordinate relationship. In the embodiment, the PCB locating module 102 records a coordinate value of each of the components in the PCB file, so that each component of the PCB has a coordinate value that is recorded in the PCB file.

In block S24, the image conversion module 103 converts the PCB file into a PCB image using a visual graphic tool, and displays the PCB image on the display device 3. In one embodiment, the visual graphic tool may be an ALLEGRO viewer that can convert the PCB file into the PCB image.

In block S25, the component identifying module 104 searches a test point on the PCB image according to a name of a component of the PCB. In the embodiment, the component may be a resistor whose name is represented by R080_{—}103T, which is input from an input device (e.g., a keyboard) of the computing device 1.

In block S26, the component identifying module 104 identifies the component on the PCB according to the test point, and obtains a coordinate value of the component according to the coordinate relationship between the test point and the component. For example, if the name of component is R080_{—}103T, the component identifying module 104 identifies the component on the PCB using a special mark, such as a red rectangle or a red circle, and obtains a coordinate (080, 103) as the coordinate value of the component.

In block S27, the component identifying module 104 displays the name and the coordinate value of the identified component on the display device 3. For example, the name “R080_{—}103T” and the coordinate value (080, 103) of the component are displayed on the display device 3, so the user can easily find the location of the component on the PCB using the name and the coordinate value of the component.

All of the processes described above may be embodied in, and fully automated via, functional code modules executed by one or more general purpose processors of computing devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device electronically connected to a digital scanner and a display device, the computing device comprising:
a storage system;
at least one processor; and
one or more programs stored in the storage system and executed by the at least one processor, the one or more programs comprising:
a printed circuit board (PCB) scanning module that obtains PCB data of a PCB using the digital scanner, and generates a PCB file according to the PCB data;
a PCB locating module that selects one or more location points from the PCB, locates a coordinate point for each of the location points according to the PCB file, and builds a coordinate relationship between each of the location points and the corresponding coordinate point;
a image conversion module that converts the PCB file into a PCB image using a visual graphic tool; and
a component identifying module that searches a test point on the PCB image according to a name of a component of the PCB, identifies the component on the PCB according to the test point, and obtains a coordinate value of the component according to the coordinate relationship.

2. The computing device according to claim 1, wherein the component identifying module further displays the name and the coordinate value of the identified component on the display device.

3. The computing device according to claim 1, wherein the PCB data comprises an ID number of each component, a name of each component, a location of each component, and layout information of each component in the PCB.

4. The computing device according to claim 1, wherein the visual graphic tool is an ALLEGRO viewer that is used to convert the PCB file into the PCB image.

5. A method for identifying components of a printed circuit board (PCB) using a computing device, the computing device being connected to a digital scanner and a display device, the method comprising:
obtaining PCB data of the PCB using the digital scanner, and generating a PCB file according to the PCB data;
selecting one or more location points from the PCB, and locating a coordinate point for each of the location points according to the PCB file;
building a coordinate relationship between each of the location points and the corresponding coordinate point;
converting the PCB file into a PCB image using a visual graphic tool;
searching a test point on the PCB image according to a name of a component of the PCB; and
identifying the component on the PCB according to the test point, and obtaining a coordinate value of the component according to the coordinate relationship.

6. The method according to claim 5, further comprising:
displaying the name and the coordinate value of the identified component on the display device.

7. The method according to claim 5, wherein the PCB data comprises an ID number of each component, a name of each component, a location of each component, and layout information of each component in the PCB.

8. The method according to claim 5, wherein the visual graphic tool is an ALLEGRO viewer that is used to convert the PCB file into the PCB image.

9. A non-transitory storage medium having stored thereon instructions that, when is executed by at least one processor of a computing device, causes the computing device to perform a method for identifying components of a printed circuit board (PCB) using a computing device, the computing device being connected to a digital scanner and a display device, the method comprising:
obtaining PCB data of the PCB using the digital scanner, and generating a PCB file according to the PCB data;
selecting one or more location points from the PCB, and locating a coordinate point for each of the location points according to the PCB file;
building a coordinate relationship between each of the location points and the corresponding coordinate point;
converting the PCB file into a PCB image using a visual graphic tool;
searching a test point on the PCB image according to a name of a component of the PCB; and
identifying the component on the PCB according to the test point, and obtaining a coordinate value of the component according to the coordinate relationship.

10. The storage medium according to claim 9, the method further comprises:
displaying the name and the coordinate value of the identified component on the display device.

11. The storage medium according to claim 9, wherein the PCB data comprises an ID number of each component, a name of each component, a location of each component, and layout information of each component in the PCB.

12. The storage medium according to claim 9, wherein the visual graphic tool is an ALLEGRO viewer that is used to convert the PCB file into the PCB image.

13. The storage medium according to claim 9, wherein the storage medium is selected from the group consisting of a hard disk drive, a compact disc, a digital video disc, and a tape drive.
